(19) United States
(12) Patent Application Publication
(10) Pub. No.: US 2002/0069821 A1
(43) Pub. Date: Jun. 13, 2002

(54) Set for producing labels

(76) Inventors: Thomas Pieper, Sersheim (DE); Jurgen Hermann, Bietigheim-Bissingen (DE)

Correspondence Address: Pauley Petersen Kinne & Fijer, Suite 365, 2800 West Higgins Road, Hoffman Estates, IL, 60195, US

(21) Appl. No.: 09/928,905

(22) Filed: Aug. 13, 2001

Related U.S. Application Data
(63) Continuation-in-part of application No. 09/903,424, filed on Jul. 11, 2001.

(30) Foreign Application Priority Data
Aug. 12, 2000 (DE) 200 13 961.4

(51) Int. Cl. B05C 11/11

(52) U.S. Cl. 118/504

(57) ABSTRACT

A set for producing labels, having an interactive printing program for an information carrier containing a configurable print image, having labels, which are applied with an adhesive surface to a carrier in an easily removable manner. A transparent cover material forming a laminar layer for covering the applied print image, wherein the cover material is a moisture-repellent plastic foil, is applied to a further carrier with a further adhesive layer in an easily removable manner and has UV protection to prevent the fading of the print image. A lasting, for example over several years, contrast and color brightness, along with great mechanical stability, are achieved because the cover material is of polyester and has a thickness of between 20 and 100 μm.

### BACKGROUND OF THE INVENTION

1. Field of the Invention

The invention relates to a set for producing labels, having an interactive printing program for an information carrier containing a configurable print image, having labels, which are applied with an adhesive surface to a carrier in an easily removable manner, and having a transparent cover material forming a laminar layer for covering the applied print image. The cover material is a moisture-repellent plastic foil, which is applied to a further carrier with a further adhesive layer in an easily removable manner and has UV protection to prevent the fading of the print image.

1. Description of Related Art

A set of this type for producing labels is known from German Patent Reference DE 198 50 031 A1. Different labels can be produced with an interactive program in a simple manner, using this known set. Manipulation there is easy because of the structure of the labels and of the cover material, and a relatively great weathering resistance and UV resistance is achieved when used outdoors.

A further set for producing labels is known from pages 50, 51 of the sales prospectus “Designware” of the Sigel GmbH & Co. firm of Mertingen. The designs which can be printed on the labels can be represented on a screen using appropriate software and can be designed by the user with design and graphic tools. No detailed information is provided regarding the type of the labels.

A label printer is known from German Patent Reference DE 195 47 461 A1, which is used for printing self-adhesive pricing labels, for example.

### SUMMARY OF THE INVENTION

One object of this invention is to provide a set which makes it possible for the user to easily produce particularly resistant permanent labels, along with a free design of the imprinted matter.

This object is accomplished with a set for producing labels, as set forth in this specification and the characteristics of the claims. The cover material is made of polyester and has a thickness between 20 and 100 μm.

The cover material of polyester not only results in a great mechanical stability but, at the mentioned thickness, also has a high UV shielding property starting at approximately 380 nm, wherein the UV shielding is evenly distributed over the UV A-range, UV B-range and UV C-range. In this UV range shielding up to 90% in relation to the visible range above approximately 380 nm is achieved. Thus, the fading of the printed label is prevented over several years. The cover material itself also does not turn yellow, so that a high degree of transparency and contrast is retained with brilliant colors.

Foil thicknesses between 40 and 80 μm, preferably between 50 and 60 μm, are particularly selected for handling and UV shielding. These provide sufficient stiffness, so that the danger of wave formation during adhesion and a sufficiently large amount of dinginess are obtained.

If the further adhesive surface is of a transparency at least in the UV A-range, UV B-range or UV C-range, which is reduced by at least 50% with respect to the visible spectral range, then the UV shielding is improved, and it is possible with appropriate additives to the adhesive to compensate spectral ranges of the cover material of increased transmission.

Good UV shielding properties result from the cover material being made of polyethylene naphthalate.

Other advantages result from molecular structures and/or additives, which reduce the transparency to UV radiation, being contained in the cover material. It is thus possible to further affect the spectral shielding ranges in a positive manner.

A simple concise covering of the label with covering material is achieved because the covering material in the form of a plastic foil has the same outer shape as the associated label.

Simple handling and an unhampered even attachment of the cover material to the label are assured because the cover material has a grasping tab which protrudes beyond the outer contour and which is attached to the contour by a perforation. A grasping tab can be formed inside the outer contour because the further carrier is cut in such a way that, for handling the cover material when the label is glued on, the carrier initially remains attached to the cover material when the cover material is pulled off. Because of the grasping tab, fingers do not touch at any place of the adhesive surface within the contour of the cover. With the first variation, the grasping tab can be removed without difficulties after adhesion to the contour, while with the second variation the outer contour remains unchanged and at the end of the adhesive process it is merely necessary to remove the piece of carrier remaining in the area of the grasping tab. During production the carrier is cut out from the back in the area of the grasping tab, while the label itself remains untouched in the area of the tab.

Handling and exact application, or laminating, of the cover material to the respective labels is easier because positioning aids are on the carrier near the labels on the carrier, and because there are complementary positioning aids near the cover material located on the further carrier which, during laminating, can be brought into congruency with the positioning aids. In one embodiment which is advantageous with respect to production and visibility the positioning aids and the complementary positioning aids are embodied as continuous perforations.

Steps are advantageous for the resistance and a permanent dimensional accuracy, wherein the labels are made of a polyester foil, and a surface, which can be imprinted with ink, is formed on the polyester foil. Because of the treatment of the surface, the polyester foil can preferably be imprinted with ink, wherein the ink dries quickly and a good color reproduction is assured. But printing with other customary printers, for example laser printers, is also possible. The polyester foil can be disposed of in an environmentally beneficial manner. Because of the accuracy of size, unsightly edges are prevented.

Measures are advantageous for producing the labels and the cover material, i.e. the sets, wherein the labels and the cover material are arranged in appropriate positions on congruent sheets. For example, the sheets can be processed by the same punch press for cutting out the labels and the cover material during their production. The user can find the labels and the associated cover materials on the sheets at corresponding locations.

A compact disk, a diskette or a card-shaped memory device are particularly suitable as information carriers for the printing program.

To preset a certain uniformity of the labels, further steps are advantageous, wherein the labels have preprinted fields and/or frames. Printing is simplified for the user because the program is matched to the position and size of the labels on the sheets.

### BRIEF DESCRIPTION OF THE DRAWINGS

This invention is explained in detail in view of an exemplary embodiment and the drawings, wherein:

FIGS. 1 and 1A each shows a label located on a sheet, in a top view and in cross section, respectively;

FIGS. 2 and 2A each shows cover material for the labels located on a further sheet, in a top view and in cross section, respectively; and

FIGS. 3A-3F illustrate six labels having various print images.

### DESCRIPTION OF PREFERRED EMBODIMENTS

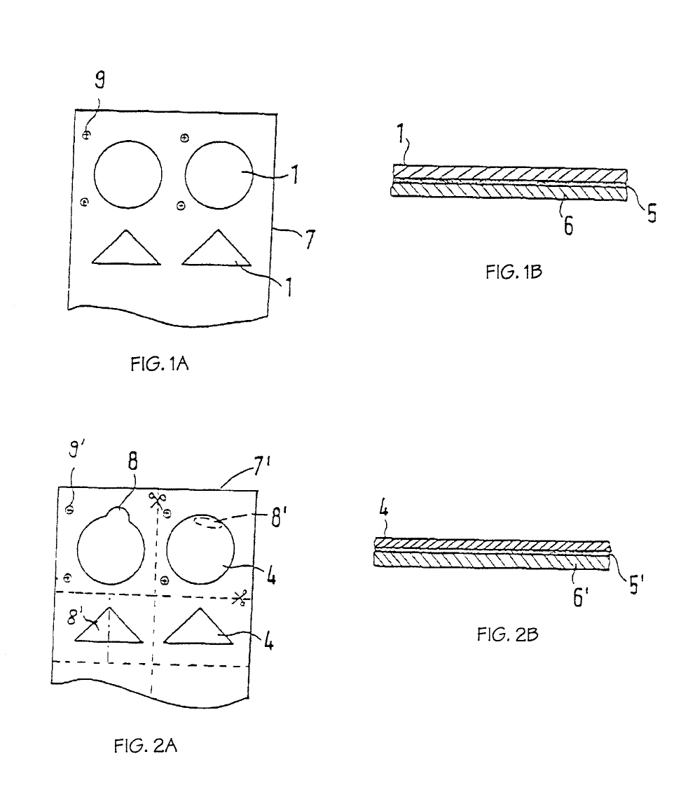

As shown in FIG. 1, differently shaped labels 1 are punched out from a sheet 7, for example. In the cross section shown in FIG. 2A, the sheet 7 has an upper layer with punched-out labels 1, an adhesive layer 5 adhering to sheet 7, and a carrier material 6, from which the label 1 with the adhesive layer 5 can be easily removed.

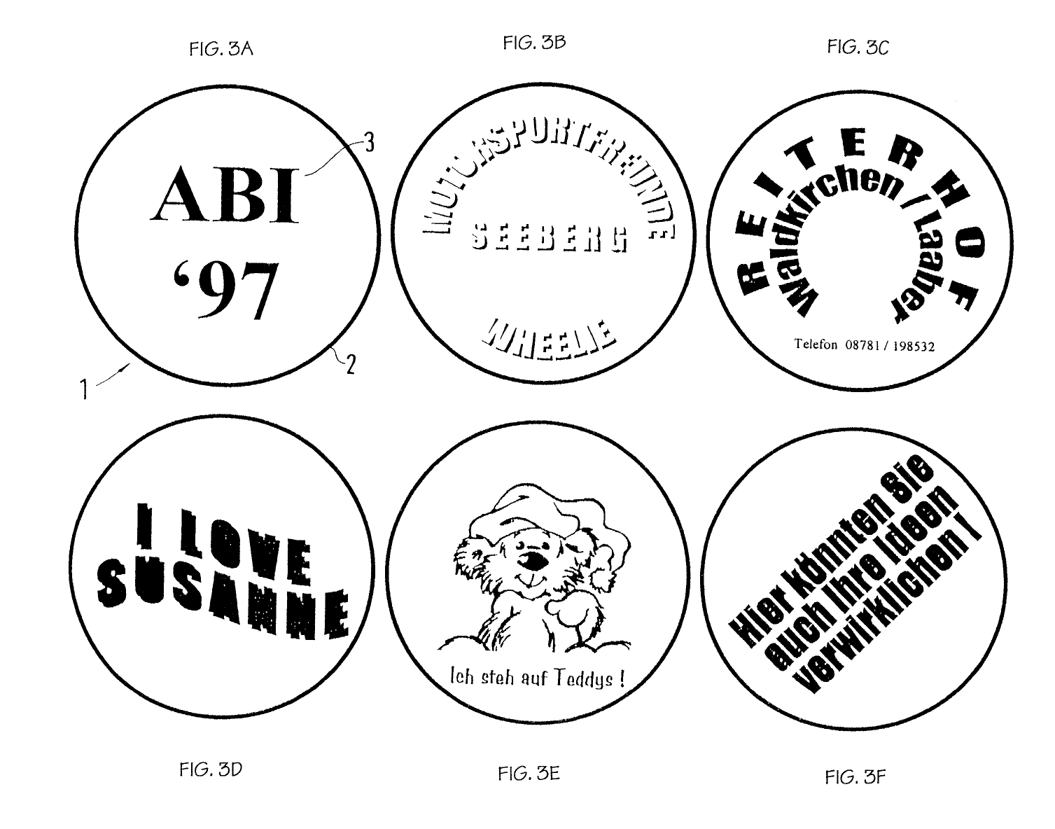

The upper layer with the labels 1 is preferably of a plastic material, in particular a polyester foil. A surface coating is applied to the polyester foil, which is also particularly suitable for imprinting in colors by means of a relatively inexpensive, commercially available ink jet printer in connection with a personal computer. Imprinting with a laser printer is also possible. The ink on the surface coating dries within a few seconds, so that the danger of damaging the print image 3, such as shown in FIG. 3, is kept as low as possible.

A sheet 7′, as shown in FIG. 2, with a format that corresponds to the format of the sheet 7 shown in FIG. 1 and which supports a cover material 4 in the form of a plastic foil, is shown in FIG. 2. The cover material 4 has a shape corresponding to that of the associated label 1 and is also arranged on the corresponding location of the sheet 7′, so that it can be processed by the same punch press as the sheet 7 with the labels 1. As the cross section shows in FIG. 2A, on its surface the sheet 7′ has a foil with the cover material 4, which has on its underside an adhesive layer 5′ adhering to it, which is applied in an easily lifted-off manner on a further carrier material 6′. The foil-like cover material 4 has an abrasion-resistant, weathering-resistant and UV light-shielding polyester material, in particular polyethylene or polyethylene naphthalate, which consistently assures, for example over one to two years, that no fading of the this cover material 4 itself, and in particular of the print image 3, occurs after the cover material 4 is attached as a protection to the label 1. The strength of the mentioned material lying between 20 and 100 μm is particularly suitable because of the small UV transmission, starting at approximately 380 nm, and because of the easy handling during application. Lesser thicknesses of the material can easily lead to waviness, while greater thicknesses of the material have too little flexibility. Material thicknesses between 40 and 80 μm in particular, and preferably between 50 and 60 μm, are suitable. It is also advantageous if in addition the adhesive layer displays a transmission in the UV range which is reduced, for example, by more than 60%, wherein the spectral range can be suitably matched to the spectral range of the cover material 4 by means of appropriate additives in order to increase its UV-shielding effect. Moreover, the exterior of the cover material 4 can be coated with a mechanically stable material on its exterior.

A grasping tab 8 projecting beyond the outer contour of the cover material 4, or a grasping tab 8′ located within the outer contour of the cover material 4, are provided on the cover material 4 for a simplified handling of the cover material 4 when it is being pulled off the further sheet 7′ and the label 1 is applied. The grasping tab 8 located outside of the outer contour is perforated in the area of the outer contour, so that it can be easily removed from the cover material 4 after being glued to the label 1. The grasping tab 8′ located inside the outer contour is formed by the further carrier material 6′ being punched out around the area of the grasping tongue, or is only slit (for example approximately in the center) in an area underneath the cover material 1 in a form of a plastic foil, but without cutting through the cover material 4 itself inside the outer contour. In this way the piece of the further carrier material 6′ lying inside the grasping tab 8′ remains on the cover material 4 when the cover material 4 is pulled off the further sheet 7′, so that the cover material 4 can be easily grasped when applied to the label 1, without negatively affecting the adhesive layer 5′ of the cover material 4. Following adhesion, the piece of carrier material in the area of the grasping tab 8′ can be completely removed, and the cover material 4 can be completely glued to the label 1.

For a simple, congruent application of the cover material 4 to the labels 1, the sheets 7 of the carrier 6 have positioning aids 9, and the sheets of the further carriers 6′ with the cover materials 4 have complementary positioning aids 9′. During laminating the positioning aids 9 and the complementary positioning aids 9′ are brought into congruence with each other. For example, individual cover material 4 and the grid surrounding it can be cut out of the further sheet 7′ with the further carrier 6′ along cutting lines, indicated by dashed lines in FIG. 2, and positioned on the label 1 to be laminated. Thereafter, the further carrier material 6′ adhering to the cover material 4 is first removed from a side opposite the complementary positioning aid 9′, and the cover material n this area is glued to the label 1. Subsequently, the further carrier material 6′ is completely removed from the remainder of the cover material 4 and is completely glued to the label 1. Handling is improved by the grasping tab 8′, or the slitting of the further carrier with this embodiment. The positioning aids 9 and the complementary positioning aids 9′ are preferably formed of at least two continuous perforations in the sheet 7, or the further sheet 7′, per the label 1, or the cover material 4. Thus, the perforations can also be used for inserting pins, or similar aids for positioning, for example.

FIG. 3 shows, by way of example, round labels 1, which can already have a border 2, for example in color. The user can produce desired imprints on a monitor by with a program, which is adapted to the format of the sheets 7 with the labels 1 and to the shape and location of the labels 1. The program is made available on an information carrier, such as a diskette, a compact disk, or the like, in a set with the label sheets. The label sheets, and also the individual labels 1, can have an identification, which is detected in a detection stage of the program for adapting the size and position of a print image 3. The user can integrate a prepared print image 3 in the desired labels 1 interactively at the monitor, wherein these can be displayed, and can also subsequently let them be printed out in the desired design in the desired colors by means of a color printer.

The labels 1 can originally consist of a durable material, and the set additionally contains the durable foils matched to the shape of the labels in order to impart weathering resistance, smearing resistance, UV stability and/or surface protection to the labels 1.

Thus the set offers the possibility of producing individual durable labels 1 in a simple manner, which can also be employed outdoors in particular.

What is claimed is:

1. In a set for producing labels (1), having an interactive printing program for an information carrier containing a configurable print image for the labels (1) which are applied with an adhesive layer (5) to a carrier (6) in a removable manner, and having a transparent cover material (4) forming a laminar layer for covering the applied print image (3), wherein the cover material (4) is a moisture-repellent plastic foil, which is applied to a further carrier (6′) with a further adhesive layer (5′) in the removable manner and has a UV protection to prevent fading of the print image (3), the improvement comprising:
the cover material (4) being of a polyester and having a thickness of between 20 and 100 μm.

2. In the set in accordance with claim 1, wherein the thickness is between 40 and 80 μm.

3. In the set in accordance with claim 2, wherein the further adhesive layer (5′) has a radiation transparency which at least in one of a UV A-range, a UV B-range and a UV C-range is reduced by at least 50% with respect to a visible spectral range.

4. In the set in accordance with claim 3, wherein the cover material (4) is of polyethylene naphthalate.

5. In the set in accordance with claim 4, wherein at least one of molecular structures and additives which reduce a UV radiation transparency are contained in the cover material (4).

6. In the set in accordance with claim 5, wherein the cover material (4) has a same outer contour as the label (1).

7. In the set in accordance with claim 6, wherein one of the cover material (4) has a grasping tab (8) which protrudes beyond an outer contour and which is attached to the outer contour by a perforation, and the grasping tab (8′) is formed inside the outer contour with the further carrier (6′) cut so that, for handling the cover material (4) when the label (1) is adhered, the further carrier (6′) initially remains attached to the cover material (4) when the cover material (4) is pulled off.

8. In the set in accordance with claim 7, wherein the labels (1) and the cover material (4) are arranged in corresponding positions on congruent sheets (7, 7′).

9. In the set in accordance with claim 8, wherein a plurality of positioning aids (9) are near the labels (1) located on the carrier (6), and a plurality of complementary positioning aids (9′) are near the cover material (4) located on the further carrier (6′) which can be brought into congruence with the positioning aids (9) during lamination.

10. In the set in accordance with claim 9, wherein the positioning aids (9) and the complementary positioning aids (9′) are embodied as continuous perforations.

11. In the set in accordance with claim 10, wherein the labels (1) are of a polyester foil, and a surface which can be imprinted with ink is formed on the polyester foil.

12. In the set in accordance with claim 11, wherein the information carrier is a one of a compact disk, a diskette and a card-shaped memory device.

13. In the set in accordance with claim 12, wherein the labels (1) have at least one of preprinted fields and borders (2).

14. In the set in accordance with claim 13, wherein the program is matched to the position and size of the labels (1) on the sheets.

15. In the set in accordance with claim 1, wherein the further adhesive layer (5′) has a radiation transparency which at least in one of a UV A-range, a UV B-range and a UV C-range is reduced by at least 50% with respect to a visible spectral range.

16. In the set in accordance with claim 1, wherein the cover material (4) is of polyethylene naphthalate.

17. In the set in accordance with claim 1, wherein at least one of molecular structures and additives which reduce a UV radiation transparency are contained in the cover material (4).

18. In the set in accordance with claim 1, wherein the cover material (4) has a same outer contour as the label (1).

19. In the set in accordance with claim 1, wherein one of the cover material (4) has a grasping tab (8) which protrudes beyond an outer contour and which is attached to the outer contour by a perforation, and the grasping tab (8′) is formed inside the outer contour with the further carrier (6′) cut so that, for handling the cover material (4) when the label (1) is adhered, the further carrier (6′) initially remains attached to the cover material (4) when the cover material (4) is pulled off.

20. In the set in accordance with claim 1, wherein the labels (1) are of a polyester foil, and a surface which can be imprinted with ink is formed on the polyester foil.

21. In the set in accordance with claim 1, wherein the labels (1) and the cover material (4) are arranged in corresponding positions on congruent sheets (7, 7′).

22. In the set in accordance with claim 1, wherein the information carrier is a one of a compact disk, a diskette and a card-shaped memory device.

23. In the set in accordance with claim 1, wherein the labels (1) have at least one of preprinted fields and borders (2).

24. In the set in accordance with claim 1, wherein the program is matched to the position and size of the labels (1) on the sheets.

25. In the set in accordance with claim 1, wherein a plurality of positioning aids (9) are near the labels (1) located on the carrier (6), and a plurality of complementary positioning aids (9′) are near the cover material (4) located on the further carrier (6′) which can be brought into congruence with the positioning aids (9) during lamination.

26. In the set in accordance with claim 25, wherein the positioning aids (9) and the complementary positioning aids (9′) are embodied as continuous perforations.
